(19) United States
(12) Patent Application Publication
(10) Pub. No.: US 2010/0121743 A1
(43) Pub. Date: May 13, 2010

(54) System and method for generating dividend information

(75) Inventors: Julian Clark, Earls Colne (GB); Edward J. Coad, Chatham, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: JP Morgan Chase Bank, New York, NY (US)

(21) Appl. No.: 11/104,785

(22) Filed: Apr. 13, 2005

(51) Int. Cl. G06Q 40/00

(52) U.S. Cl. 705/30

(57) ABSTRACT

In a system for generating dividend information, detailed information regarding trades is stored in a data storage system. The detailed information may include, without limitation, book information, depot information, counterparty information, a trade direction (e.g., buy or sell), and a number of shares traded. Based upon the detailed trade information, dividend information is generated that may be used for both PNL purposes and for accounting purposes. The detailed trade information may also include whether the trade is an “ex-div” trade, a “cum-div” trade, or neither. Trades normally eligible for a dividend are excluded from dividend information generation when identified as an ex-div trade. Trades not normally eligible for a dividend are included in dividend information generation when identified as a cum-div trade.

### FIELD OF THE INVENTION

This invention relates to a system and a method for generating dividend information. In particular, the present invention relates to generating stock dividend information used to calculate both profit and loss information and accounting information.

### BACKGROUND OF THE INVENTION

A common stock trade involves an exchange of both cash and stock certificates. The cash is exchanged between the involved parties' bank accounts, and the stock certificates are exchanged between depots. A depot is a location where stock certificates are physically held. In the United States, only one depot exists, the DTC. In Europe, however, multiple depots exist. A custodian is an entity that manages a depot. The custodian receives and pays money on behalf of the company whose stock was traded and handles transferring the traded stock certificates to another depot, if necessary. The custodian also retains records as to who currently owns the stock certificates in its depot.

To further describe a common stock trade, assume that “Investor A” buys stock of “Company A” from “Investor B.” From Investor A's perspective, Investor B is a “counterparty” to the transaction, and from Investor B's perspective, Investor A is a counterparty to the transaction. Also assume that Investor A is located in a region associated with “Depot A,” which is managed by “Custodian A.” Further, assume that Investor B is located in a region associated with “Depot B,” which is managed by “Custodian B.” The date of the trade is referred to as the “trade date.” Sometime after the trade date, typically a few days, the trade is settled. Settling of the trade, called “settlement,” involves the actual transfer of cash from Investor A's bank account to Investor B's bank account, as well as the transfer of stock certificates from Depot B to Depot A via interactions between Custodian B and Custodian A. The date that the trade is settled is called the “settlement date,” which marks the conclusion of the trade transaction and the date when the Custodians become aware of the new stock owner as a result of the transaction.

A dividend is a payment made by a company to its stockholders. A company is not required to issue dividends, but doing so provides investors with an incentive to purchase or retain ownership of the company's stock. When a company intends to issue dividends to its stockholders, the company typically announces when the dividend is to be issued. Because stock is frequently traded, the financial industry has used a few critical dates to determine who will be entitled to the dividend payment, to whom the dividend payment will actually be made, and when a dividend payment will be made. In typical chronological order, these dates are called an “ex-date,” a “record date,” and a “payment date,” respectively.

With reference to FIG. 1, the ex-date is a date typically specified by the company issuing the dividend and is the first date on which the investors who trade for the common stock associated with the dividend is not entitled to receive the dividend. On the other hand, if an investor trades for the stock before the ex-date, he or she is entitled to the dividend. Accordingly, for common stock trades, the trade date is compared to the ex-date to determine entitlement. For example, if “Company A” is going to issue dividends to its stockholders, Company A may decide that the ex-date will be December 1. The investors who trade for Company A's stock before December 1 are entitled to the dividend. However, the investors who trade for Company A's stock on or after December 1 are not entitled to the dividend.

Sometimes an investor acquires stock through a trade after the ex-date, and although not entitled to the dividend, would still like to receive it. In this case, the investor may negotiate to pay a higher fee for the stock or some off-balance sheet agreement in return for the right to receive the dividend. Such an arrangement is called a “cum-div” bargain condition meaning “with dividend.” On the other hand, an investor may acquire stock prior to the ex-date and, although entitled to receive the dividend, may negotiate with its counterparty not to receive it in return for paying a lower price for the stock. Such an arrangement is called an “ex-div” bargain condition meaning “without dividend.”

The record date is a date arriving after the ex-date, typically by a few days. On the record date, a list of stock owners to which dividends will be distributed is obtained from the appropriate custodian. Accordingly, one purpose of the record date is to allow trades time to settle so that the custodian has, for the most part, a list of the most current stock owners. If a trade settles on or before the record date, the transaction is complete, and the new stock owner is recorded by the appropriate custodian. In this situation, the custodian will distribute the dividends to the correct stock owner on the payment date. If a trade settles after the record date, the appropriate custodian is not aware of the transaction and, consequently, is not aware of the new stock owner. In this situation, the custodian will distribute the dividend to the previous stock owner, and the new stock owner will have to make a claim against the previous stock owner (i.e., new stock owner's counterparty) to recover the dividend, if the new stockholder is entitled to the dividend. The payment date occurs after the record date and is the date that the dividend is actually paid.

Turning now to FIG. 2, assume that a common stock trade from Investor A to Investor B occurs prior to the ex-date. As shown in FIG. 1, Investor B is entitled to the dividend. If the trade settles on or before the record date, Investor B is the owner of record and receives the dividend payment. However, if the trade settles after the record date, Investor B is not yet the owner of record even though Investor B is entitled to receive the dividend. In other words, the appropriate custodian is not aware that Investor B is the new stock owner. Consequently, Investor A receives the dividend payment from the custodian on the payment date, and Investor B must then make a claim for the dividend against Investor A.

The record date is also used to determine entitlement in a specific type of stock trade called a “Stock Borrow Loan” or “SBL” trade. An SBL trade is sometimes referred to as a repo or reverse-repo transaction. Contrary to a common stock trade, the stock owner in an SBL trade lends its stock to another investor, but retains ownership of the stock. For example, if Investor A owns Company A's stock, Investor A may lend the stock it owns to Investor B. Even though Investor B obtains “possession” of the stock, Investor A retains ownership of the stock. However, the custodian involved in the transaction does not differentiate between SBL trades and common stock trades and, therefore, treats the transaction as if ownership rights were transferred. As far as the custodian is concerned, Investor B is the owner of the stock.

As shown in FIG. 3, if an investor acquires stock in an SBL trade, and the SBL trade is settled on or before the record date, the investor is entitled to the dividend, because the custodian treats the investor as the owner of the stock. If an investor acquires stock in an SBL trade, and the SBL trade is settled after the record date, the investor is not entitled to the dividend. Accordingly, for SBL trades, the settlement date is compared to the record date to determine entitlement, and the trade date is irrelevant. On the other hand, for common stock trades, as described with reference to FIG. 1, the settlement date is irrelevant when determining entitlement.

Stock trading has been an enormous industry for quite some time. Companies that are involved in this industry often have hundreds, if not thousands, of employees called “traders” who are responsible for trading stock. Accounting for the enormous amount of transactions that occur on a daily basis is not a trivial task. With respect to dividends, trade dates, settlement dates, ex-dates, record dates, payment dates, etc., must all be tracked for each trade that occurs. Further, these companies need to know each trader's overall profit and loss (“PNL”) with respect to dividends for any given day. When a dividend is announced for a particular stock, PNL for each trader is calculated on the ex-date for such dividend. PNL is calculated for a trader by multiplying the net number of shares for the company issuing the dividend that the trader traded by the dividend amount. The net number of shares is calculated by subtracting the total number of shares sold from the total number of shares bought. The information needed to calculate PNL, i.e., the information about all of the trader's trades, is stored in what is called the trader's “book,” which is a listing of every trade executed by the trader. Accordingly, it is said that the conventional PNL dividend information calculated at the ex-date is calculated at a “book level.”

Additionally, companies need to know dividend amounts that are expected to be received from and distributed to particular depots or other entities for accounting purposes. Such information is generated on the record date, when new stock owners are known to the appropriate custodians. Accordingly, it is said that the conventional accounting dividend information calculated at the record date is calculated at a “depot level.”

Calculation of the aforementioned PNL and accounting dividend information will become more clear by considering the example shown at FIG. 4, which illustrates a conventional scheme for calculating such information. The left-hand side 402 of FIG. 4 illustrates the generation of PNL dividend information for each trader at the ex-date for a stock having dividends issued. Box 406 represents a sum of all settled and unsettled trades for each trader as of the ex-date, where “Book 123” is associated with one trader, “Book 345” is associated with another trader, and so on. For PNL purposes, no distinction between settled and unsettled trades is necessary.

The phrase “risk position” means a sum of the shares of all settled and unsettled trades, where shares purchased with a buy trade are represented as positive numbers, and shares sold with a sell trade are represented as negative numbers. For example, with reference to item 408, assume that Book 123 is associated with “Trader X.” Also assume that within Book 123 are a buy trade of 2000 shares that has settled and a sell trade of 500 shares that has not settled (also referred to as an “open” trade). Because the risk position is the sum of all settled and unsettled trades, the risk position for Trader X (Book 123) is (2000+(−500)), or 1500 shares, as shown at item 410.

As can be seen for PNL calculations, the dividend information is calculated at a book level, i.e., the trades are summed for each book (Book 123, Book 345, Book 456, and Book 567). Accordingly, dividend amounts are calculated for each trader by multiplying each trader's risk position 410, 412, 414, and 416 by a dividend-per-share amount announced by the company issuing the dividend.

The right-hand side 404 of FIG. 4 illustrates the generation of dividend information for accounting purposes at the record date for a stock having dividends issued. Contrary to PNL dividend information, it is important to make a distinction between settled and unsettled trades when calculating dividend information for accounting purposes. To elaborate, the applicable custodians are aware of the new stock owner for trades that have settled on or before the record date. Accordingly, for settled trades, the dividend payments are received/paid directly from/to the depot. In this case, the dividend information is calculated at the depot level, as shown in box 418, to account for the dividends that are expected to be received from and/or paid to each depot. However, for a trade that has not settled on or before the record date, the custodian does not know who the new stock owner is and, consequently, pays the dividend to the previous stock owner. In this situation, a claim is made against the previous stock owner in the case of a buy trade to recover the dividend payment. In the case of a sell trade, the dividend payment is forwarded to the counterparty. Therefore, the dividend information for unsettled trades is calculated on a trade-by-trade basis, as shown in box 420, to identify which counterparties have to have claims made against them or have the dividend payments delivered to them.

Conventionally, the accounting dividend information on the right-hand side 404 is calculated at a depot level for settled trades and at a trade level for unsettled trades. Box 418 includes the sum of all shares for trades associated with a particular depot. For example, regarding item 424, assume that two trades exist involving Depot ABC: a buy trade of 1,000 shares, and a sell trade of 500 shares. To arrive at the data in item 424, the two trades are combined to arrive at a position of (1,000+(−500))=500 shares for depot ABC. Box 420 includes a list of each unsettled or “open” trade. Each unsettled trade is associated with counterparty information. Dividend amounts are calculated for each item in box 418 and each item in box 420 by multiplying each share amount 422 by the dividend per share number announced by the company issuing the dividend.

The conventional PNL and accounting-dividend-information generation schemes are cumbersome and inefficient, and a need exists in the art for an improved dividend-information generation technique.

### SUMMARY OF THE INVENTION

The deficiencies discussed above are addressed and a technical solution achieved in the art by a system and a method for generating dividend information according to the present invention. According to an embodiment of the invention, detailed information regarding trades is stored in a data storage system. The detailed trade information may include, without limitation, book information, depot information, counterparty information, a trade direction (e.g., buy or sell), and a number of shares traded. Based upon the detailed trade information, dividend information is generated that may be used for both PNL purposes and accounting purposes at a record date. By generating dividend information that may be used for both PNL and accounting purposes, instead of generating separate dividend information for PNL purposes and accounting purposes, processing time, data storage requirements, and reconciliation and operations efforts are reduced.

According to another embodiment of the invention, the dividend information includes (a) book, depot, and settled-position information regarding settled common stock trades having a same book and a same depot, and (b) book, counterparty, and quantity of shares traded information for each open common stock trade. Such dividend information may be used to generate both PNL and accounting information. The dividend information may also include book, depot, and settled-position information regarding stock borrow loan trades.

According to yet another embodiment of the present invention, the detailed trade information includes whether the trade is an “ex-div” trade, a “cum-div” trade, or neither. Trades that normally are entitled to a dividend are excluded from a procedure for generating the dividend information when they are identified as ex-div trades. Trades that normally are not entitled to a dividend are included in the procedure for generating the dividend information when they are identified as cum-div trades.

According to yet another embodiment of the present invention, one or more computers retrieve the detailed trade information from the data storage system to generate the dividend information that may be used for both PNL and accounting purposes. Prior to generation of the dividend information, the one or more computers may determine whether each trade is identified as an ex-div trade or a cum-div trade. Trades that normally are entitled to a dividend are excluded by the one or more computers when generating the dividend information if they are identified as ex-div trades. Trades that normally are not entitled to a dividend are included by the one or more computers when generating the dividend information if they are identified as cum-div trades.

### BRIEF DESCRIPTION OF THE DRAWINGS

The present invention will be more readily understood from the detailed description of preferred embodiments presented below considered in conjunction with the attached drawings, of which:

FIG. 1 illustrates entitlement rules associated with trades of common stock;

FIG. 2 illustrates when dividends are distributed to a new stock owner and when the dividends are distributed to a previous stock owner;

FIG. 3 illustrates entitlement rules associated with stock borrow loan trades;

FIG. 4 illustrates a conventional scheme for separately generating dividend information for PNL purposes and accounting purposes;

FIG. 5 illustrates a system for generating dividend information, according to an embodiment of the present invention;

FIG. 6 illustrates trade information, according to an embodiment of the present invention;

FIG. 7 illustrates a method for generating dividend information, according to an embodiment of the present invention;

FIG. 8 illustrates dividend information generated for common stock trades at an ex-date, according to an embodiment of the present invention;

FIG. 9 illustrates dividend information generated for stock borrow loan trades at an ex-date, according to an embodiment of the present invention;

FIG. 10 illustrates dividend information generated for common stock trades at a record date, according to an embodiment of the present invention;

FIG. 11 illustrates dividend information generated for stock borrow loan trades at a record date, according to an embodiment of the present invention;

FIG. 12 illustrates trade information that includes ex-div and cum-div bargain conditions, according to an embodiment of the present invention;

FIG. 13 illustrates an ex-date processing portion of a method for generating dividend information, according to an embodiment of the present invention;

FIG. 14 illustrates a record date processing portion of a method for generating dividend information, according to an embodiment of the present invention;

FIG. 15 illustrates dividend information generated for common stock trades at an ex-date where ex-div trades are excluded, according to an embodiment of the present invention; and

FIG. 16 illustrates dividend information generated for common stock trades at a record date where cum-div trades are included, according to an embodiment of the present invention.

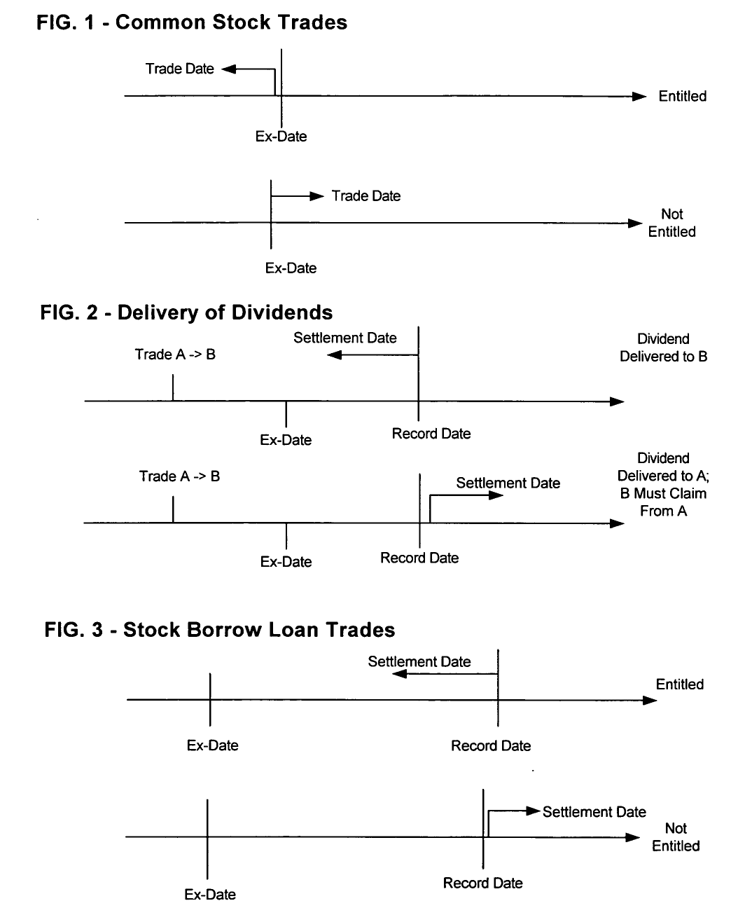

It is to be understood that the attached drawings are for purposes of illustrating the concepts of the invention and may not be to scale.

### DETAILED DESCRIPTION OF THE INVENTION

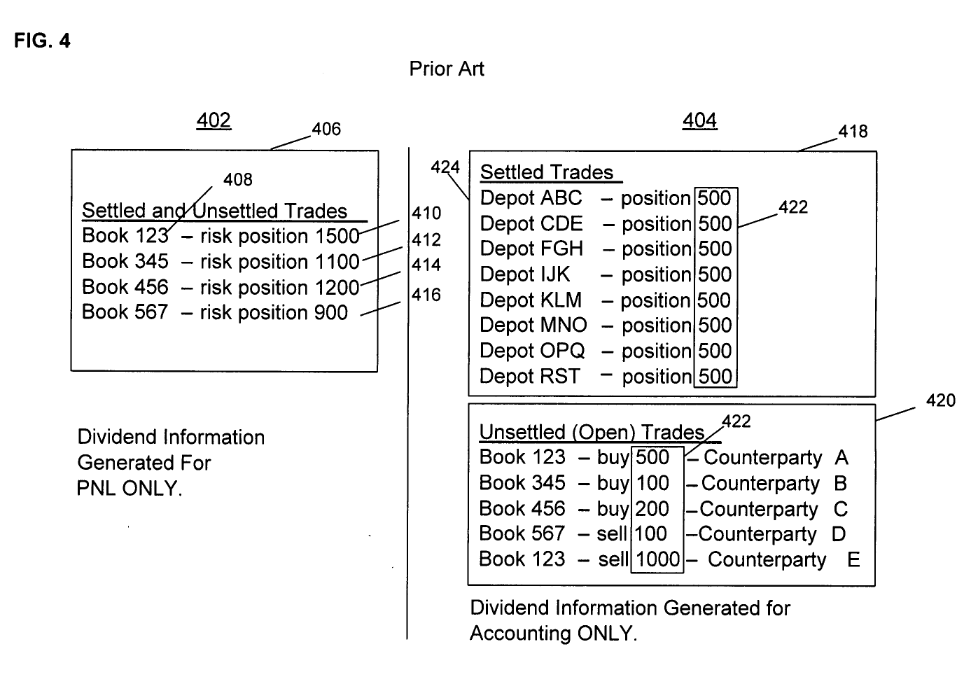

The inventors of the present invention have discovered that a shortcoming of the conventional dividend information generation scheme is that it separately generates dividend information for PNL purposes and dividend information for accounting purposes, as shown by the left-hand side 402 and right-hand side 404 of FIG. 4. Further, the dividend information generated only for PNL purposes shown on the left-hand side 402 fails to include information specifying where the dividends are to be arriving from or whether a claim will have to be made against a counterparty to recover the dividends. Additionally, the dividend information generated only for accounting purposes shown on the right-hand side 404 does not specify what books (traders) the dividends should be distributed to once received.

In response to the shortcomings of the conventional scheme, the present invention generates a single set of dividend information that may be used for both PNL and accounting purposes. Further, the dividend information generated according to an embodiment of the present invention specifies where the dividends are to be arriving from and whether a claim will have to be made against a counterparty to recover the dividends. The dividend information according to this embodiment also specifies what books (traders) the dividends should be distributed to once received. Accordingly, dividend information is generated more quickly and efficiently, and because two different sets of dividend information are no longer needed, storage requirements are reduced.

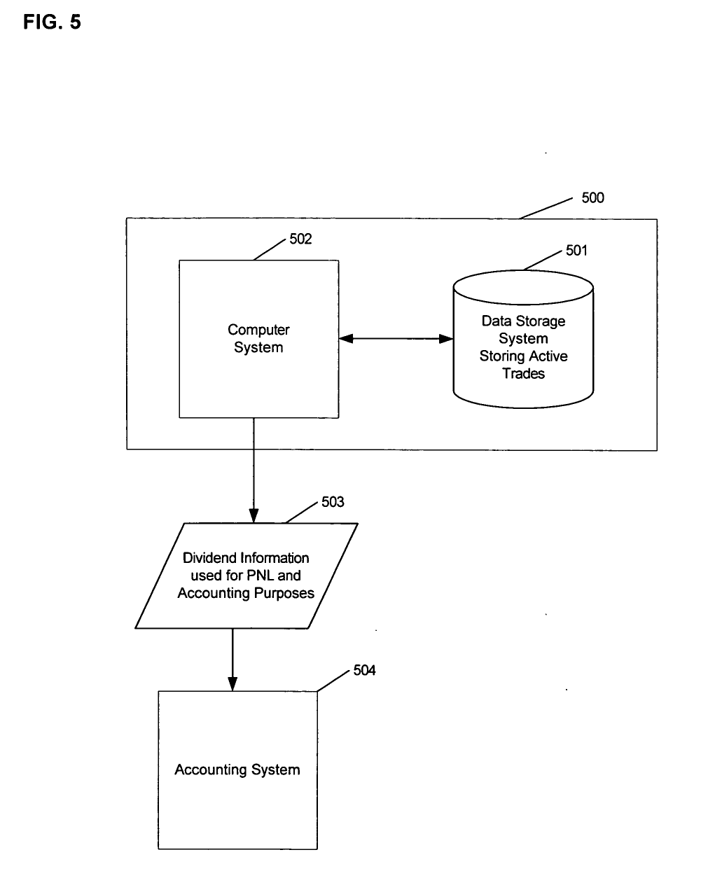

An embodiment of the present invention will now be described with reference to FIG. 5, which illustrates a system 500 for generating dividend information, according to the various embodiments of the present invention. The system 500 includes a data storage system 501 and a computer system 502 communicatively connected to each other. The data storage system 501 retains detailed information of active trades initiated by traders according to the various embodiments of the present invention disclosed herein. The computer system 502 retrieves the detailed information from the data storage system 501 and generates dividend information 503 usable for both PNL and accounting purposes according to the various embodiments of the present invention disclosed herein. The system 500 may include an accounting system 504, which may be communicatively connected to the computer system 502, that calculates dividend amounts for both PNL and accounting purposes based upon the dividend information 503. Alternatively, the computer system 502 may calculate the dividend amounts, and the dividend amounts may be included in the dividend information 503.

The computer system 502 may include one or more computers communicatively connected to each other. The data storage system 501 may include one or more computer-accessible memories. One skilled in the art will appreciate that data storage system 501 may be a distributed storage system including multiple separate computer-accessible memories stored on various computers. The data storage system 501 may also reside on a single computer-accessible memory located within a computer or other device.

The term “computer” is intended to include any data processing device, such as a desktop computer, a laptop computer, a mainframe computer, a personal digital assistant, and/or any other device for processing data, whether implemented with electrical and/or magnetic and/or optical components, or otherwise.

The term “computer-accessible memory” is intended to include any computer-accessible data storage device, whether volatile or nonvolatile, electronic, magnetic, optical, or otherwise, including but not limited to, floppy disks, hard disks, CD-ROMs, DVDs, flash memories, ROMs, and RAMs.

The term “communicatively connected” is intended to include any type of connection, whether wired or wireless, in which data may be communicated. Further, the term “communicatively connected” is intended to include a connection between devices within a single computer, a connection between computers, or a connection between devices not located in computers at all. In this regard, although the data storage system 501 is shown separately from the computer system 502, one skilled in the art will appreciate that the data storage system 501 may be stored completely or partially within the computer system 502.

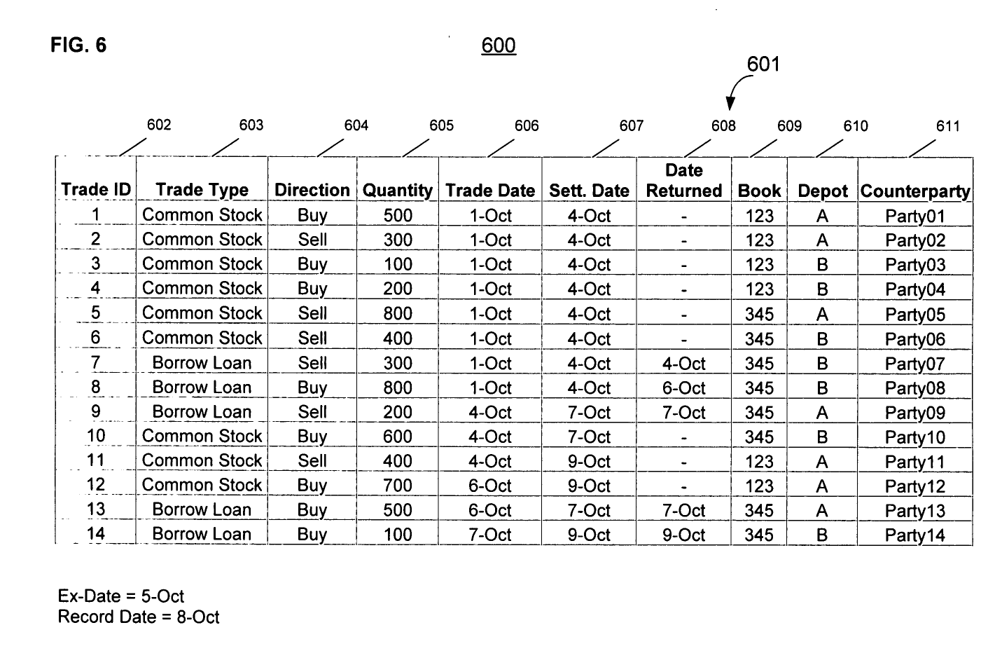

FIG. 6 illustrates an example table 601 of data 600 stored in the data storage system 501, according to an embodiment of the invention. Each row in the table 601 represents a record stored for each trade executed by a trader. According to an embodiment of the invention, each record includes a trade identifier (ID) 602, a trade type 603, a direction of the trade 604, a number of shares traded (“quantity”) 605, a trade date 606, a settlement date 607, a date returned 608 for stock borrow loan trades, a book 609, a depot 610, and a counterparty 611 associated with the trade. The trade ID 602 is optional, but is included for clarity.

The trade type 603 identifies the type of trade, which may be, for example, a common stock trade or a stock borrow loan trade. The direction of the trade 604 identifies whether the trade is a buy trade or a sell trade. The quantity 605 specifies the number of shares traded. The trade date 606 is the date that the trade was initiated by the trader associated with book 609 and the counterparty 611. The settlement date 607 is the date that the trade was settled. If the trade has not settled, the settlement date 607 may be blank, have a null value, or may have some other value to indicate that the trade has not settled. The date returned 608 applies only to stock borrow loan trades and indicates the date when the loaned stock is returned to the stock owner. The book 609 identifies the book of the trader who executed the trade. The depot 610 indicates the depot from which payment will be received or the depot to which payment will be made, depending upon the direction 604 of the trade. The counterparty 611 indicates the party with which the trade was executed. Although the counterparty 611 in FIG. 6 shows only a name, such as “Party01,” complete contact information may be included. Optionally, a separate database includes the contact information, and the counterparty 611 is identified only by the name of the counterparty. In this situation, the contact information may be cross-referenced using the name identified in the counterparty 611 portion of the table 601.

Although not shown in FIG. 6, the data 600 also includes an identification of the stock traded, such as a stock ticker, a company name, etc. For clarity, however, such information has been left out, and all trades shown in FIG. 6 are deemed to be associated with the same stock for which dividends are to be issued. One skilled in the art will appreciate, however, that any trade associated with any stock may be included in the data 600.

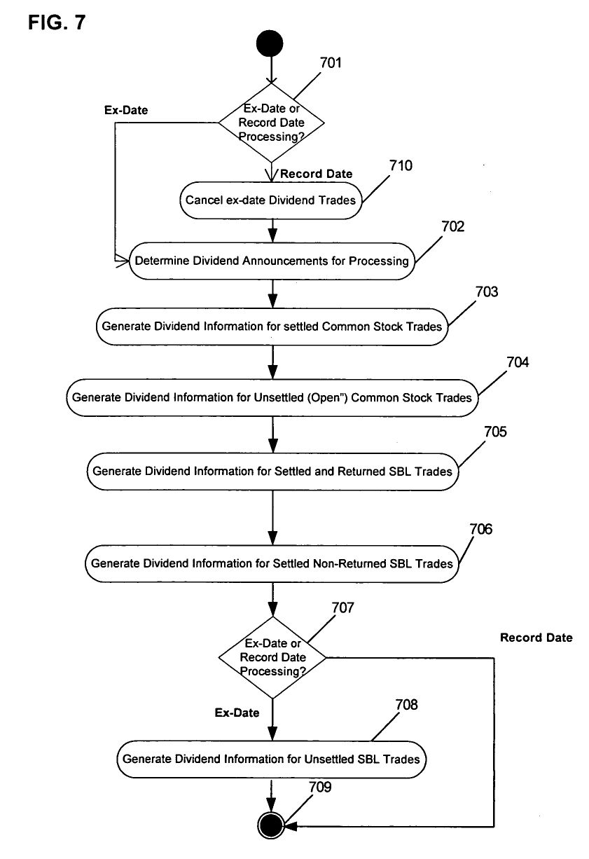

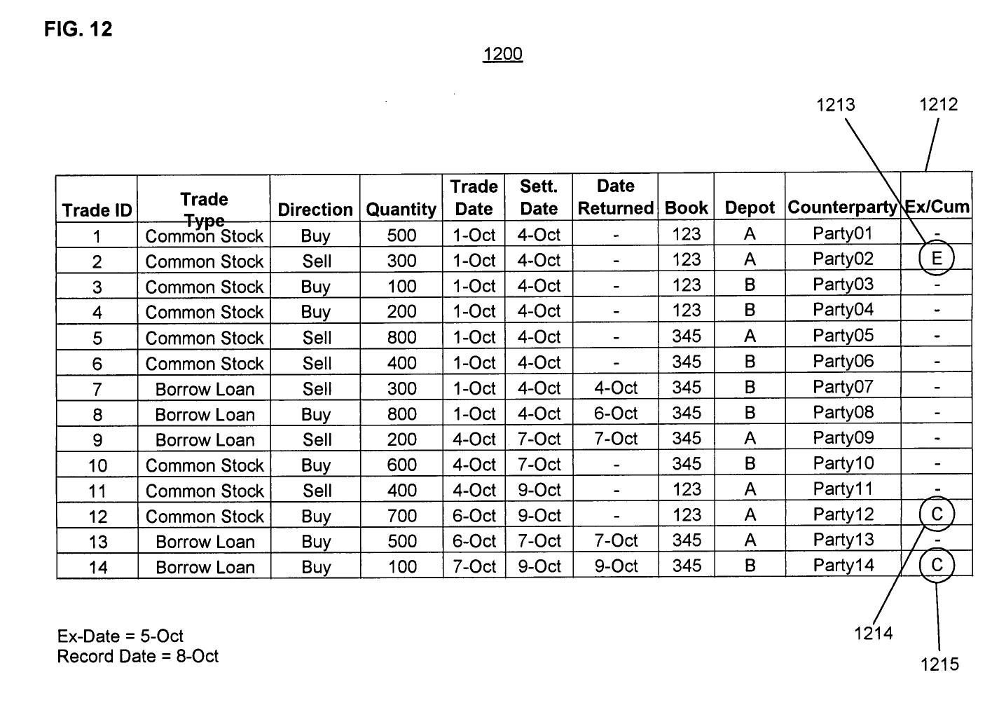

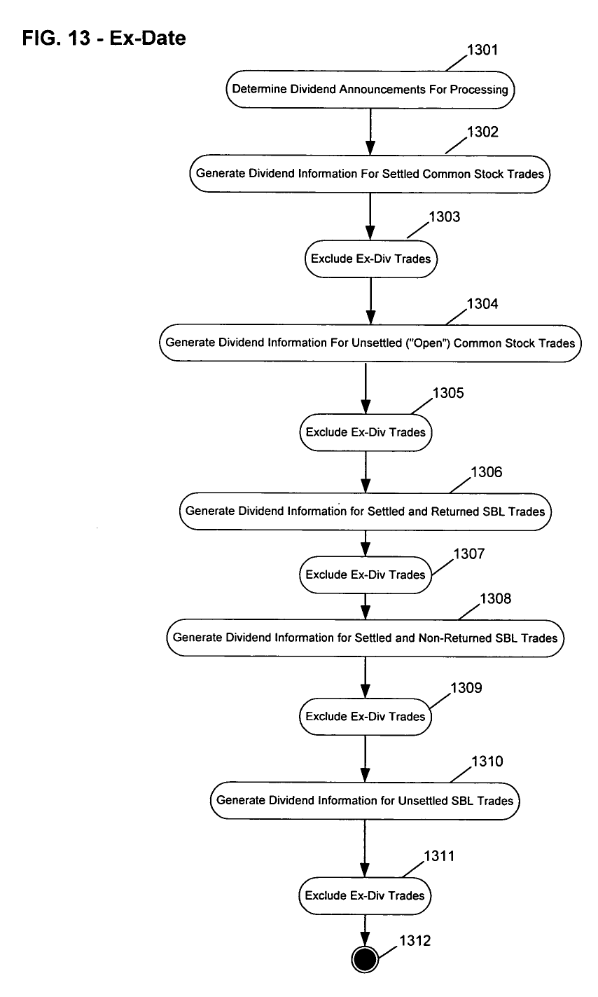

An example of how the data 600 is processed according to an embodiment of the invention will now be described with reference to FIG. 7. Although FIG. 7 (and FIGS. 12 and 13, for that matter) are shown to have an ordering of steps, one skilled in the art will appreciate that some or all of the steps may be independent and may be performed in any order. For the embodiment of FIG. 7, it is assumed that dividends are to be issued for the stock associated with the trades shown in FIG. 6. It is also assumed that the ex-date for the dividends is October 5 and the record date is October 8. Generation of dividend information according to the process illustrated in FIG. 7 occurs once at the ex-date for PNL purposes and again at the record date for at least accounting purposes. Processing at the record date also may be performed for PNL purposes if the data 600 is changed between the ex-date and the record date. The dividend-information generation techniques disclosed herein enable the generation of such dividend information to be more efficient, take less time, and require less storage than conventional schemes.

Beginning at step 701, it is determined whether ex-date or record date processing is to occur. Ex-date processing may be performed anytime after the close of business on the day prior to the ex-date, and record date processing may be performed anytime after the close of business on the record date. For ex-date processing, step 710 is skipped and processing advances to step 702. At step 702, dividend announcements are identified. In other words, stock for which dividends are to be issued are identified. Trades involving the stock identified at step 702 may have dividend information generated for them in the following steps.

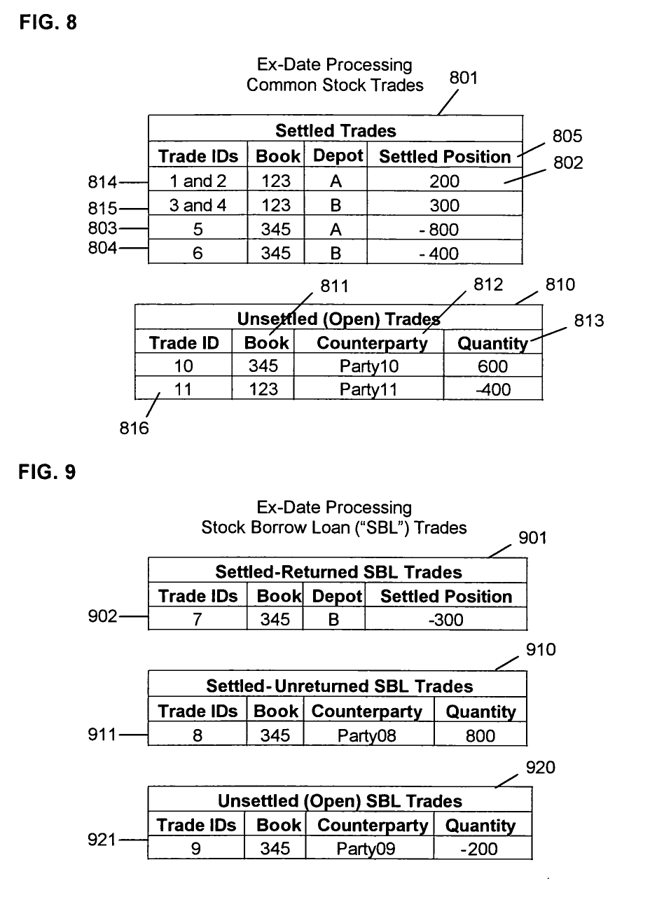

At step 703, dividend information is generated for settled common stock trades. An example of the dividend information generated at this step from the data 600 is shown at the table 801 in FIG. 8. Because the ex-date is assumed to be October 5, the common stock trades that have settled on or before October 5 are trades 1-6, as identified by the Trade ID 602 portion of FIG. 6. According to this embodiment of the invention, the dividend information in the table 801 is generated at a book-depot level so that such information may be used for both PNL and accounting purposes. Therefore, the dividend information in the table 801 is aggregated according to trades having the same book and the same depot. For example, trades 1 and 2 both have a book of “123” and a depot of “A.” Consequently, their quantities 605 are aggregated at item 814 in FIG. 8, such that buy trades are counted as a positive quantity, and sell trades are counted as a negative quantity. In particular, the quantity for trade 1 is positive 500 shares because it is a buy trade. The quantity for trade 2 is negative 300 shares because it is a sell trade. Therefore, 500 minus 300 equals the settled position of 200, shown at item 802 in FIG. 8.

At item 815 in the table 801, trades 3 and 4 are combined because they both pertain to book “123” and depot “B.” As shown at items 803 and 804 in FIG. 8, trades 5 and 6 are not combined with any other trade because they uniquely pertain to book “345” and depot “A,” and book “345” and depot “B,” respectively.

Step 703 may also involve generating actual dividend amounts, not shown, by multiplying the settled position 805 for each row in the table 801 by the announced dividend per share amount. For example, assume that the dividend per share is $0.01. For the settled position corresponding to the item 803, the dividend amount would be negative 800 multiplied by $0.01, which equals negative $8, meaning that $8 of dividends were lost.

At step 704, dividend information is generated for unsettled (“open”) common stock trades. An example of the dividend information generated at this step from the data 600 is shown at table 810 in FIG. 8. Because the ex-date is assumed to be October 5, the common stock trades that have not settled on or before October 5 are trades 10 and 11. According to this embodiment, dividend information for unsettled common stock trades is generated on a trade-by-trade basis to determine, among other things, (a) what counterparties need to have claims made against them for the recovery of dividends in the case of buy trades, and (b) to what counterparties dividends should be delivered in the case of sell trades. Accordingly, no aggregation of trades occurs. The information generated in the table 810 includes a book 811, a counterparty 812, and a quantity 813 of each open trade. As shown in the table 810, buy trades are represented as a positive quantity and sell trades are represented as a negative quantity.

At step 705, dividend information is generated for settled stock borrow loan (“SBL”) trades where the loaned stock has been returned to the owner. An example of the dividend information generated at this step from the data 600 in FIG. 6 is shown at table 901 in FIG. 9. As shown at item 902, trade 7 is the only SBL trade that has settled on or before the ex-date processing (October 5) and that has had its loaned stock returned to the owner as of the ex-date processing. It should be noted that trade 8 is absent from the table 901 because, as of October 5, its stock has not been returned to its owner. Additionally, trade 9 is absent from the table 901 because, as of October 5, it has not settled.

As with the generation of dividend information for settled common stock trades at step 703, the dividend information in the table 901 is generated at a book-depot level so that such information may be used for both PNL and accounting purposes. Therefore, the dividend information in the table 901 is aggregated according to trades having the same book and the same depot. However, because only one settled and returned SBL trade exists in the data 600, no aggregation has occurred in this example.

At step 706, dividend information is generated for settled SBL trades that have not had their loaned stock returned to the stock owner. To illustrate, assume that company X and company Y enter into an SBL trade where company X loans company Y some of the stock it owns. In this situation, company Y is in possession of the stock, but company X retains ownership of the stock. Accordingly, because company Y is in possession of the stock, it will receive the dividend. However, company Y does not have rights to the dividend because it is not the owner. Therefore, the dividend received by company Y typically is transferred to company X, the entity that is entitled to the dividend. The amount transferred to company X is called a “manufactured dividend” and typically is less than the actual dividend amount because of taxes applied to the dividend are deducted. The dividend information generated at step 706 may be used to generate manufactured dividends for these settled SBL trades that have not had their loaned stock returned to the stock owner.

An example of the dividend information generated at step 706 from the data 600 is shown at table 910 in FIG. 9. As shown at item 911, trade 8 is the only SBL trade that has settled on or before ex-date processing at October 5 and that has not had its loaned stock returned to the stock owner as of the time of ex-date processing. As with the generation of dividend information for unsettled common stock trades at step 704, the dividend information in the table 910 is generated on a trade-by-trade basis to determine, among other things, (a) what counterparties need to have claims made against them for the recovery of manufactured dividends in the case of buy trades, and (b) to what counterparties manufactured dividends should be delivered in the case of sell trades. Accordingly, no aggregation of trades occurs.

At step 707, it is determined whether ex-date processing or record date processing is occurring. In the case of ex-date processing, step 708 is executed. Otherwise, processing ends at step 709.

At step 708, dividend information is generated for unsettled SBL trades. Unsettled SBL trades are not necessarily entitled to dividends, as discussed with respect to FIG. 3. An SBL trade is entitled to a dividend only if it settles on or before the record date. However, in most circumstances, if the trade date for an SBL trade is on or before the ex-date, the trade is expected to settle before the record date. Accordingly, dividend information may be generated for the unsettled SBL trades at the ex-date based upon the expectation that they will settle prior to the record date.

An example of the dividend information generated at step 708 from the data 600 is shown at table 920 in FIG. 9. As shown at item 921, the only SBL trade that has not settled on or before the ex-date processing of October 5 is trade 9. According to an embodiment of the present invention, dividend information for unsettled SBL trades is generated on a trade-by-trade basis. Accordingly, no aggregation of trades occurs.

FIG. 7 now will be described from the perspective of record date processing. Record date processing may build upon the dividend information generated during ex-date processing (FIGS. 8 and 9, for example), or record date processing may start from scratch without utilizing the dividend information generated during ex-date processing. If the latter is chosen, step 710 may be executed at the initiation of record date processing, where the dividend information generated during the ex-date processing is deleted. If the former is chosen, step 710 may be skipped, and record date processing may begin at step 702. At step 702, dividend announcements are identified as they are with ex-date processing.

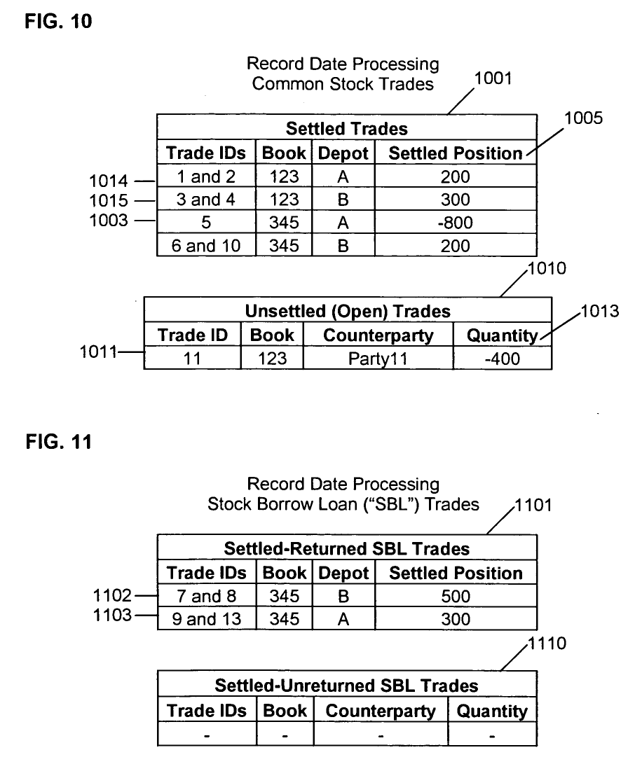

At step 703 for record date processing, dividend information is generated for common stock trades that have settled on or before the record date. An example of the dividend information generated at this step from the data 600 is shown at table 1001 in FIG. 10. Because the record date is assumed to be October 8, trades 1-6 and 10 are the only common stock trades that have settled on or before October 8. However, dividend information for trades 1-6 was generated during the ex-date processing, as shown at the table 801. Accordingly, such information need not be re-generated, and only trade 10 needs to be added to the table 1001. One skilled in the art will appreciate, however, that the dividend information in the table 1001 for all trades 1-6 and 10 can be recreated at step 703 during record date processing, if desired, instead of adding trade 10 to the table 801 to arrive at the table 1001.

At step 704 for record date processing, dividend information is generated for unsettled (“open”) common stock trades. An example of the dividend information generated at this step from the data 600 is shown at table 1010 in FIG. 10. Because the record date is assumed to be October 8, trades 11 and 12 are the only common stock trades that have not settled on or before the record date. Trade 11 is included in the table 1010 at item 1011. However, trade 12 is excluded from the table 1010 because it was traded after the ex-date and, therefore, is not eligible for dividends. The table 1010 may be generated from scratch or by updating the table 810 by deleting trade 10, which has settled since the ex-date and, consequently, has been moved to the table 1001.

At step 705 for record date processing, dividend information is generated for settled stock borrow loan (“SBL”) trades where the loaned stock has been returned to the owner. An example of the dividend information generated at this step from the data 600 is shown at table 1101 in FIG. 11. As shown at items 1102 and 1103, trades 7, 8, 9, and 13 are the only SBL trades that have (a) settled on or before the record date of October 8 and (b) have had their loaned stock returned to the owner as of the record date. The table 110 1 may be generated by updating the table 901 to include: trade 8, whose stock has been returned since the ex-date; trade 9 which has settled and been returned since the ex-date; and trade 13, which has been traded, settled, and returned since the ex-date. Trades 7 and 8 are combined in row 1102 because they apply to the same book and the same depot. Likewise, trades 9 and 13 are combined in row 1103 because they apply to the same book and the same depot.

At step 706 for record date processing, dividend information is generated for settled SBL trades that have not had their loaned stock returned to the stock owner. As shown in table 1110 in FIG. 11, no settled-unreturned SBL trades exist in the data 600 as of the record date. As with the other tables, the table 1110 may be generated from scratch by scanning all of the data 600 or may be generated by modifying its associated table. In this case the table 910 has been modified by deleting trade 8, which has had its associated stock returned since the ex-date and, accordingly, has moved to the table 1101.

Step 708 is not performed for record date processing because SBL trades that have not settled on or before the record date are not entitled to dividends. Accordingly, the table 920 calculated during ex-date processing does not have a record date counterpart. Consequently, trade 14 shown in FIG. 6, which had not settled as of the record date, does not have dividend information generated for it. Further, if trade 9 shown in the table 920 had not settled by the record date, and dividend amounts were calculated for it on the ex-date, such dividend amounts would be cancelled during the record date processing because trade 9 is not eligible for dividends.

The ex-date dividend information of FIGS. 8 and 9 typically is used for PNL purposes, and the record date dividend information of FIGS. 10 and 11 typically is used for accounting purposes. However, both the record date dividend information and the ex-date dividend information are in a format that may be used by the accounting system 504 for both PNL and accounting purposes. Further, the record date dividend information builds upon the ex-date dividend information, thus eliminating the need to recreate it. Further still, the record date dividend information and the ex-date dividend information have the same format, allowing one complete set of dividend information to be generated, thereby simplifying processing and reducing storage requirements. Accordingly, valuable PNL and accounting information may be provided to companies more quickly and efficiently compared with conventional schemes.

For example, if PNL information is desired from the dividend information in FIG. 10, the settled position 1005 and the quantity 1013 for all rows pertaining to a particular book are summed and multiplied by the announced dividend per share amount. To calculate the PNL for the book 123, the settled position 1005 corresponding to items 1014 and 1015 in the table 1001 are aggregated with the quantity 1013 in the table 1010 to arrive at 100 shares. That is, 200 shares plus 300 shares minus 400 shares equals 100 shares. If the dividend per share amount is $0.01, then the PNL for the book 123 is $1.

If accounting information is desired from the dividend information in FIG. 10, the settled position 1005 for all rows pertaining to a depot are summed and multiplied by the announced dividend per share amount. For example, to determine the dollar amount expected to be received from or delivered to depot A, the settled positions 1005 corresponding to the items 1014 and 1003 in the table 1001 are summed to arrive at negative 600 shares. The negative 600 shares is then multiplied by the dividend per share amount, in this example, $0.01, to arrive at negative $6. The negative $6 indicates that $6 are currently expected to be delivered to depot A.

Further, for accounting purposes, the data in the table 1010 identifies which counterparties need to have claims made against them for the dividend amount or to which counterparties dividend amounts are to be delivered. For example, a dividend amount for trade 11 is calculated as negative 400 shares multiplied by $0.01 per share, or negative $4. The negative $4 indicates that $4 of dividends will have to be transferred to Party11, because trade 11 is a sell trade that has not settled prior to the record date.

In contrast to the present invention, the conventional scheme illustrated with FIG. 4, only calculates data for the table 406 on the ex-date for PNL purposes. Such data may not be used for accounting purposes. Separate data in the tables 418 and 420 must be generated at the record date for accounting purposes. Accordingly, unnecessary additional processing occurs in the conventional schemes, and additional data is generated, thereby requiring more complexity and data storage space than the present invention.

Turning now to FIG. 12, another embodiment of the invention will be described. According to this embodiment, additional data is recorded with respect to each trade to identify whether the trade includes an ex-div or a cum-div bargain condition. For example, data 1200 in FIG. 12 mimics the data 600 in FIG. 6, but includes an extra column “Ex/Cum” 1212. An “E” in this column indicates that the corresponding trade includes an ex-div bargain condition, meaning that the trade should be excluded from dividend information generation even though the trade would normally be entitled to a dividend. As shown at item 1213, trade 2 includes an ex-div bargain condition. A “C” in this column indicates that the corresponding trade includes a cum-div bargain condition, meaning that the trade should be included in dividend information generation even though the trade would not normally be entitled to a dividend. As shown at items 1214 and 1215, trades 12 and 14 include a cum-div bargain condition.

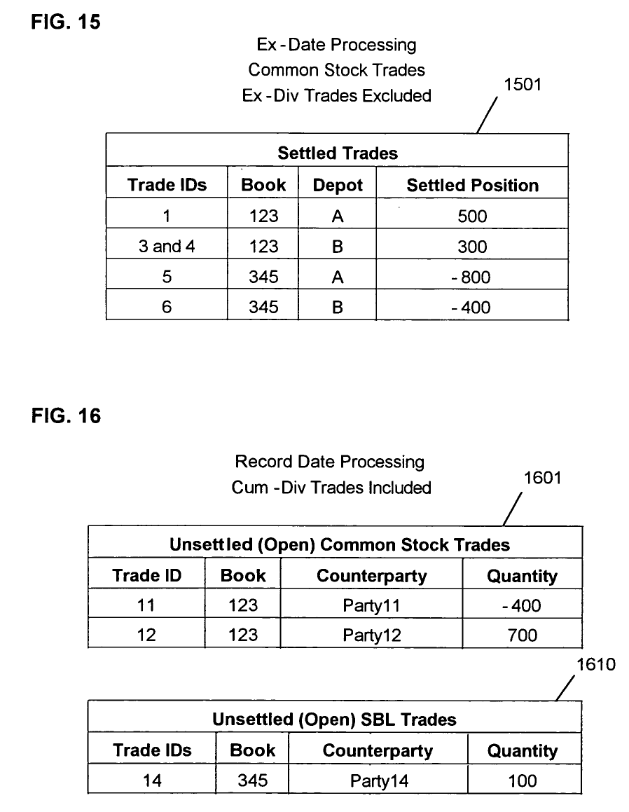

FIG. 13 illustrates ex-date processing according to an embodiment of the present invention. Step 1301 corresponds to step 702 in FIG. 7, where dividend announcements are determined for processing. Step 1302 corresponds to step 703, where dividend information for settled common stock trades is generated. Accordingly, the table 801 in FIG. 8 is generated by step 1302 when the data 1200 in FIG. 12 is used as the set of active trades. At step 1303, any trades included in step 1302 that have an ex-div bargain condition are excluded, even though they would normally be entitled to a dividend. For example, because trade 2 in FIG. 12 is marked as ex-div, it is removed from the table 801 to arrive at table 1501 shown in FIG. 15.

Step 1304 corresponds to step 704, where dividend information for unsettled common stock trades is generated. Continuing with the above example using the data 1200, step 1304 produces the table 810. At step 1305, any trades included at step 1304 that are marked as ex-div are removed from the output of step 1304. For example, any trades in the table 810 marked as ex-div are removed from the table, even though they would normally be entitled to a dividend. In this example, however, no trades included in the table 810 are marked as ex-div.

Step 1306 corresponds to step 705 and, using the data 1200, generates the table 901. At step 1307, any trades included at step 1306 that are marked as ex-div are removed from the output of step 1307. For example, any trades in the table 901 that are marked as ex-div are removed from the table even though they would normally be entitled to a dividend. In this example, however, no trades included in the table 901 are marked as ex-div.

Step 1308 corresponds to step 706 and, using the data 1200, generates the table 910. At step 1309, any trades included at step 1308 that are marked as ex-div are removed. For example, any trades in the table 910 that are marked as ex-div are removed from the table even though they would normally be entitled to a dividend. In this example, however, no trades included in the table 910 are marked as ex-div.

Step 1310 corresponds to step 708 and, using the data 1200, generates the table 920. At step 1311, any trades included at step 1310 that are marked as ex-div are removed. For example, any trades in the table 920 that are marked as ex-div are removed from the table even though they might be entitled to a dividend. In this example, however, no trades included in the table 920 are marked as ex-div. Ex-date processing concludes at step 1312.

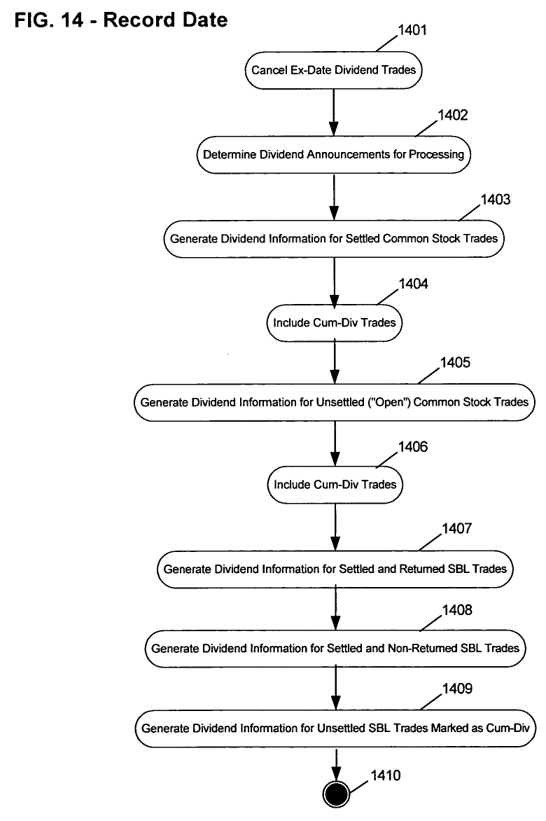

FIG. 14 illustrates record date processing according to this embodiment of the present invention. Step 1401, which is optional, corresponds to step 710, and step 1402 corresponds to step 702. Step 1403 corresponds to step 703 as performed for record date processing. Using the data 1200, step 1403 generates the table 1001. At step 1404, any trades in the data 1200 that are identified as cum-div, were traded after the ex-date, and settled on or before the record date are included with the trades identified at step 1403, even though they would not normally be entitled to a dividend. For example, if a trade in the data 1200 met such requirements, it would be included in the table 1001 at step 1404. However, no trades in data 1200 met such requirements, and accordingly, the table 1001 remains unchanged.

Step 1405 corresponds to step 704 as performed for record date processing. Using the data 1200, step 1405 generates the table 1010. At step 1406, any trades in the data 1200 that are identified as cum-div, were traded after the ex-date, and remain unsettled as of the record date are included with the trades identified at step 1405, even though they would not normally be entitled to a dividend. For example, trade 12 in the data 1200 meets such requirements, and is added to the table 1010, thereby generating the table 1601 in FIG. 16.

Step 1407 corresponds to step 705 as performed for record date processing. Using the data 1200, step 1407 generates the table 1101. Because the trades included in step 1407, e.g., those trades in the table 1101, are already entitled to a dividend, no additional step of including cum-div trades is required.

Step 1408 corresponds to step 706 as performed for record date processing. Using the data 1200, step 1408 generates the table 1110. As with step 1407, these trades already are entitled to a dividend, and, consequently, no additional step of including cum-div trades is required.

Step 1409 has no counterpart in FIG. 7, but generates dividend information for unsettled SBL trades marked as cum-div. Because SBL trades that remain unsettled at the record date are not entitled to a dividend, they may be marked as cum-div so that they become entitled to dividends. For example, trade 14 in FIG. 12 is an SBL trade that has not settled as of the record date, October 8. However, because it is marked as cum-div, it is included when the dividend information is generated so that it may receive the dividend even though it would normally not be entitled to the dividend. Accordingly, using the data 1200, step 1409 generates the table 1610 shown in FIG. 16. Record date processing concludes at step 1410.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

1. A computer-implemented method for generating dividend information for at least one stock having a dividend, the dividend having an ex-date and a record date, the method comprising the steps of:
retrieving trade data pertaining to a plurality of trades associated with the at least one stock for which dividends are to be issued, the trade data being retrieved from a data storage system;
generating a consolidated set of dividend information from the retrieved trade data, wherein the consolidated set of dividend information is generated by a computer system configured for use in both ex-date processing and record date processing, and wherein the consolidated set of dividend information comprises data specifying the source of the dividends, data specifying a claim against a counterparty to recover dividends and data specifying distributions of the dividends; and
calculating profit and loss (PNL) information on the ex-date and accounting information pertaining to receipts and disbursements on the record date using the consolidated set of dividend information generated from the retrieved trade data.

2. (canceled)

3. The method of claim 1, wherein the consolidated set of dividend information generated for use in ex-date processing further comprises data pertaining to settled common-stock trades, the data pertaining to the settled common-stock trades being generated from information related to the trader book, the depot and an aggregated settled position.

4. The method of claim 3, wherein the aggregated settled position is comprised from trades having the same trader book and depot.

5. The method of claim 1, wherein the consolidated set of dividend information generated for use in ex-date processing further comprises data pertaining to unsettled common-stock trades, the data pertaining to the unsettled common-stock trades being generated from information related to the trader book, the counterparty and the quantity associated with the transaction.

6. The method of claim 5, wherein the unsettled common-stock trade data is generated on a trade-by-trade basis.

7. (canceled)

8. The method of claim 1, wherein:
the consolidated set of dividend information generated includes settled common-stock trade data,
the settled common-stock trade data includes a plurality of first records, each first record identifying at least one of a trader book, a depot and a settled position for settled common-stock trades having the same trader book and the same depot in the plurality of trades,
the consolidated set of dividend information generated includes unsettled common-stock trade data,
the unsettled common-stock trade data includes a plurality of second records, each second record identifying at least one of a trader book, a counterparty and a quantity associated with the transaction pertaining to the number of shares traded for unsettled common-stock trades in the plurality of trades, and
the PNL is generated by:
calculating a first dividend amount for each first record and a second dividend amount for each second record, and
aggregating the first dividend amount(s) and the second dividend amount(s) for each first and second record associated with the same trader book.

9. The method of claim 8, wherein:
the first dividend amount(s) is/are calculated for each first record by multiplying the settled position of a first record by a dividend-per-share amount, and
the second dividend amount(s) is/are calculated for each second record by multiplying the quantity of shares traded of a second record by the dividend-per-share amount.

10. The method of claim 1, wherein retrieving trade data further comprises retrieving bargain condition data specifying whether the trade has an ex-div bargain condition, a cum-div bargain condition, or no bargain condition.

11. The method of claim 10, wherein the data specifying whether the trade has the cum-div bargain condition is included in the consolidated set of dividend information generated.

12. The method of claim 10, wherein the data specifying whether the trade has the ex-div bargain condition is excluded from the consolidated set of dividend information generated.

13. A computer readable medium having stored thereon a plurality of instructions, the plurality of instructions including instructions that, when executed by a processor, cause the processor to perform the steps of a method for generating dividend information, said method comprising the steps of:
retrieving trade data pertaining to a plurality of trades associated with the at least one stock for which dividends are to be issued;
generating a consolidated set of dividend information from the retrieved trade data, wherein the consolidated set of dividend information is generated for use in both ex-date processing and record date processing, and wherein the consolidated set of dividend information comprises data specifying the source of the dividends, data specifying a claim against a counterparty to recover dividends and data specifying distributions of the dividends; and
calculating profit and loss (PNL) information on the ex-date and accounting information pertaining to receipts and disbursements on the record date using the consolidated set of dividend information generated from the retrieved trade data.

14-21. (canceled)
